(19) United States
(12) Patent Application Publication
(10) Pub. No.: US 2026/0301267 A1
(43) Pub. Date: Oct. 1, 2026

(54) CONTROL METHOD, ELECTRONIC DEVICE, AND INTERACTIVE SYSTEM

(71) Applicant: Lenovo (Beijing) Limited, Beijing (CN)

(72) Inventor: Di XIAO, Beijing (CN)

(21) Appl. No.: 19/574,052

(22) Filed: Mar. 20, 2026

(30) Foreign Application Priority Data
Mar. 31, 2025 (CN) 202510401112.6

(51) Int. Cl. G06T 11/60; G06F 3/0354; G06F 3/041

(52) U.S. Cl. CPC G06T 11/60; G06F 3/03545; G06F 3/041; G06T 2210/62

(57) ABSTRACT

A control method includes outputting a first image when an electronic device is in a first state, and in response to a preset condition being met, switching the electronic device to a second state and outputting the first image and a second image. First image content of the first image is visible in the second state. The method further includes, in response to receiving an input signal, adjusting at least one of the first image content or second image content of the second image. The input signal represents an operation instruction for the first image or the second image.

### CROSS-REFERENCE TO RELATED APPLICATION

This application claims priority to Chinese Patent Application No. 202510401112.6, filed on Mar 31, 2025, the entire content of which is incorporated herein by reference.

### TECHNICAL FIELD

The present disclosure generally relates to a control method, an electronic device, and an interactive system.

### BACKGROUND

When using applications on electronic devices such as tablets, users often have sudden inspirations on content such as images, text, or videos displayed within the applications. For example, users might mark, annotate, or modify the content. However, performing these operations will affect the user’s ability to use the current application on the electronic device.

### SUMMARY

In accordance with the disclosure, there is provided a control method including outputting a first image when an electronic device is in a first state, and in response to a preset condition being met, switching the electronic device to a second state and outputting the first image and a second image. First image content of the first image is visible in the second state. The method further includes, in response to receiving an input signal, adjusting at least one of the first image content or second image content of the second image. The input signal represents an operation instruction for the first image or the second image.

Also in accordance with the disclosure, there is provided an interactive system including an electronic device and a stylus. The electronic device is configured to output a first image when the electronic device is in a first state, and in response to a preset condition being met, switch to a second state and output the first image and a second image. First image content of the first image being visible in the second state. The electronic device is further configured to, in response to receiving an input signal, adjust at least one of the first image content or second image content of the second image. The input signal represents an operation instruction for the first image or the second image. The stylus is configured to input the input signal.

Also in accordance with the disclosure, there is provided an electronic device including a processor, and a memory storing an application program that, when executed by the processor, causes the electronic device to, output a first image when the electronic device is in a first state, and in response to a preset condition being met, switch to a second state and output the first image and a second image. First image content of the first image is visible in the second state. The application program, when executed by the processor, further causes the electronic device to, in response to receiving an input signal, adjust the image content of at least one image of the first image or the second image. The input signal represents an operation instruction for the first image or the second image.

### BRIEF DESCRIPTION OF THE DRAWINGS

The above and other objects, features, and advantages of the present disclosure will become clearer from the following description of the embodiments of the present disclosure with reference to the accompanying drawings.

FIG. 1 is a flowchart of a control method consistent with the present disclosure.

FIG. 2 schematically illustrates a scenario of state transition of an electronic device consistent with the present disclosure.

FIG. 3 schematically illustrates a scenario of image adjustment of a second image consistent with the present disclosure.

FIG. 4 schematically illustrates one scenario of image content adjustment of an electronic device consistent with the present disclosure.

FIG. 5 schematically illustrates another scenario of image content adjustment of an electronic device consistent with the present disclosure.

FIG. 6 is a structural schematic diagram of an electronic device consistent with the present disclosure.

FIG. 7 is a structural schematic diagram of an interactive system suitable for implementing the methods described above consistent with the present disclosure.

FIG. 8 is a structural schematic diagram of another electronic device suitable for implementing the methods described above consistent with the present disclosure.

### DETAILED DESCRIPTION OF THE EMBODIMENTS

Embodiments of the present disclosure will be described with reference to the accompanying drawings. It should be understood that these descriptions are exemplary only and are not intended to limit the scope of the present disclosure. In the following detailed description, numerous specific details are set forth to provide a thorough understanding of the embodiments of the present disclosure for ease of explanation. However, it is obvious that one or more embodiments may be implemented without these specific details.

The terminology used herein is for the purpose of describing particular embodiments only and is not intended to limit the scope of the present disclosure. The terms “comprising,” “including,” etc., as used herein indicate the presence of said features, processes, operations, and/or components, but do not exclude the presence or addition of one or more other features, processes, operations, or components.

All terms used herein (including technical and scientific terms) have the meaning commonly understood by those skilled in the art, unless otherwise defined. It should be noted that the terms used herein should be interpreted in a manner consistent with the context of this specification and should not be interpreted in an idealized or overly rigid manner.

When expressions such as “at least one of A, B, or C” are used, they should generally be interpreted in accordance with the meaning commonly understood by those skilled in the art (e.g., “a system having at least one of A, B, or C” should include, but is not limited to, systems having A alone, having B alone, having C alone, having A and B, having A and C, having B and C, and/or having A, B, and C, etc.).

The present disclosure can be applied to electronic devices. The present disclosure does not limit the product form of the electronic device, and the electronic device may include, but is not limited to, smartphones, tablets, wearable devices, personal computers (PCs), netbooks, etc., and can be selected according to application needs.

A tablet computer is used as the electronic device for illustration in the present disclosure.

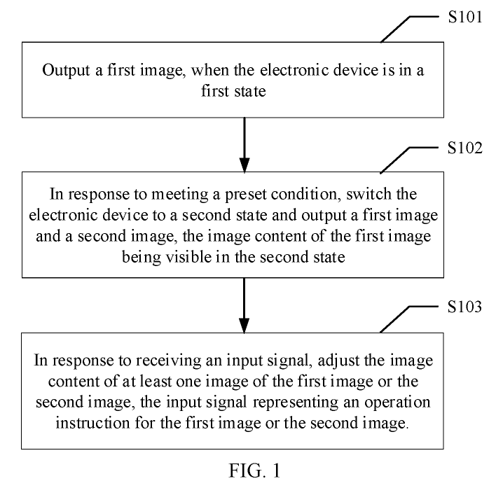

FIG. 1 is a flowchart of a control method consistent with the present disclosure.

Specifically, as shown in FIG. 1, the control method includes S101-S103.

At S101, a first image is output when the electronic device is in a first state.

At S102, in response to meeting a preset condition, the electronic device is switched to a second state and a first image and a second image are output, the image content of the first image being visible in the second state.

At S103, in response to receiving an input signal, the image content of at least one image of the first image or the second image is adjusted. The input signal represents an operation instruction for the first image or the second image. In this disclosure, the image content of the first image is also referred to as “first image content” and the image content of the second image is also referred to as “second image content.”

Specifically, in the first state, the electronic device displays corresponding images, text, or videos based on the launched application, i.e., outputs the first image. When the electronic device receives a signal that meets the preset condition, the electronic device switches from the first state to a second state. In the second state, the electronic device outputs two different layers: a first image and a second image. By configuring the positional relationship between the first image and the second image, the image content of the first image is made visible when the electronic device is in the second state.

Consistent with the present disclosure, the output image content of the second image is determined based on the input signal of the electronic device. Specifically, when the electronic device receives an input signal, the image content of either the first image or the second image can be adjusted; the image content of both images can also be adjusted simultaneously after an input signal is received. The specific adjustment depends on the target object of the input signal.

For example, the first image represents the content displayed by the application, and the second image is provided to the user to perform operations on the first image. For example, when the image content of the first image is text or video, the user’s browsing status of the first image’s content can be recorded by adding text annotations, graphic markings, etc., in the second image.

By employing the above method, the user can view the first image normally (such as the original content in the application) in the first state of the electronic device, and when the preset condition is met, the electronic device switches to the second state, simultaneously displaying the first image and the second image. This allows users to mark, annotate, and modify images, text, or videos in the first image without interrupting the current application, thus improving the user experience.

Consistent with the present disclosure, the second image is configured to be on top of the first image. The method further includes adjusting the image content of the second image to enable the image content of the first image to be visible in the second state.

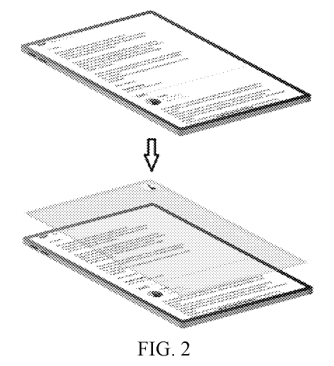

FIG. 2 schematically illustrates a scenario of state transition of an electronic device consistent with the present disclosure.

As shown in FIG. 2, the second image is on top of the first image. By configuring the second image as a layer with a certain transparency, the image content of the first image can be ensured to remain visible in the second state.

In some embodiments, the second image may also be located on the same layer as the first image, and by being adjacent to the first image, the image content of the first image is ensured to remain visible in the second state.

Consistent with the present disclosure, adjusting the image content of the second image to enable the image content of the first image to be visible in the second state includes: adjusting the image transparency of the second image to a preset value; or, adjusting the image content of the second image based on the image content of the first image to enable the image content of the first image to be displayed in the second image.

Specifically, adjusting the transparency of the second image to a preset value makes the image transparent, allowing the user to see the first image located below the second image.

By using the above method, the second image is configured as the top layer of the first image, and the image content of the second image can be adjusted to ensure that the image content of the first image remains visible in the second state. This allows the user to easily switch between or simultaneously view the original content and annotation content as needed.

Consistent with the present disclosure, the method further includes: adjusting the image content of the second image based on the image content of the first image.

At this time, the visibility of the image content of the first image in the second state does not solely depend on adjusting the transparency of the second image, a portion of the image content of the first image that the user wishes to display can also be copied and presented on the second image, enabling the user to directly view the portion of the image content of the first image that is desired to be displayed.

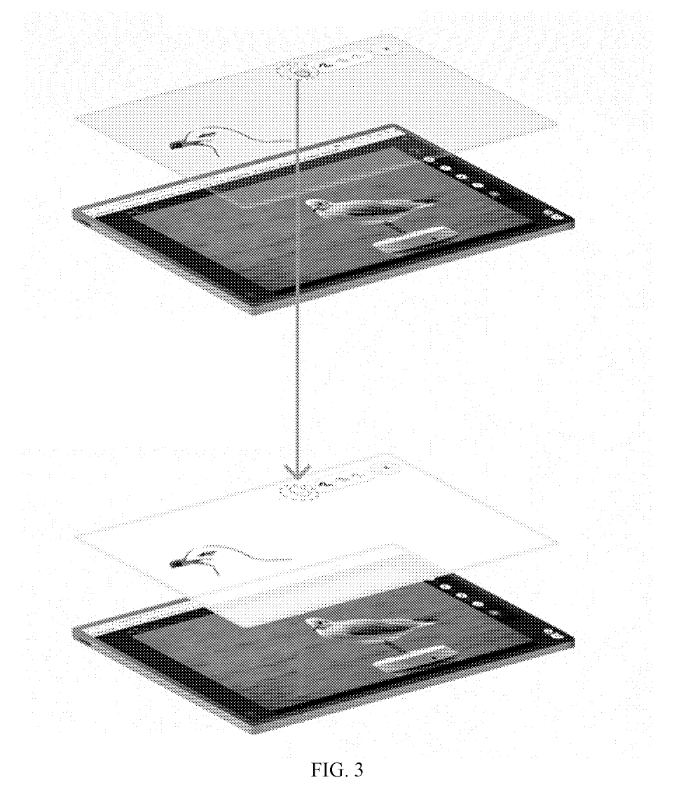

FIG. 3 schematically illustrates a scenario of adjusting the image of the second image consistent with the present disclosure.

It should be noted that, as shown in FIG. 3, the transparency of the second image can also be adjusted to an opaque state, allowing the user to mark on the second image without being disturbed by the first image. For example, when the first image is a drawing, and the user wishes to complete the drawing action using the second image, if the user wishes to avoid being influenced by the image content in the first image during the drawing process, the image transparency of the second image can be adjusted to become opaque for a certain period of time.

Consistent with the present disclosure, adjusting the image content of at least one image of the first image or the second image in response to receiving an input signal includes: adjusting the image content of the second image according to the input signal if the input signal is sent by a pre-configured signal input device; and adjusting the image content of the first image according to the input signal if the input signal is not sent by a pre-configured signal input device.

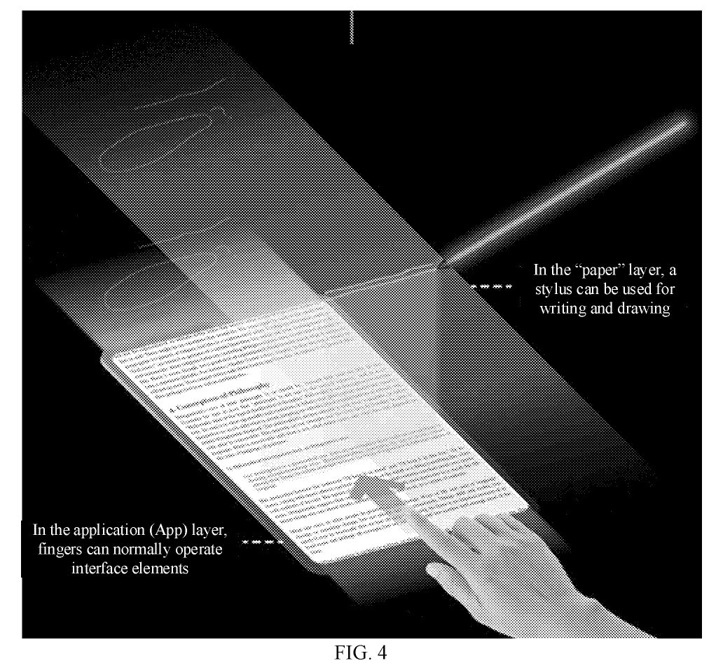

FIG. 4 schematically illustrates one scenario of image content adjustment of an electronic device consistent with the present disclosure.

As shown in FIG. 4, the source of the input signal includes the user’s hand touch or is sent through a pre-configured signal input device. The signal input device can be configured as a stylus.

Consistent with the present disclosure, when the user operates on the second image, i.e., the “Paper” layer in FIG. 4, using a stylus, the user’s operation result is displayed in the second image. When the user interacts with the electronic device using their hand instead of a stylus, it is determined that the user intends to interact with the image content of the first image. Therefore, based on the input signal, the image content of the first image is adjusted, while the image content of the second image remains unchanged. That is, if the input signal received by the electronic device is not from the stylus, it indicates that the user intends to interact with the electronic device using their hand to control the image content of the first image.

In some embodiments, the method further includes determining whether the input signal is sent from a pre-configured signal input device based on the communication protocol type of the input signal.

Specifically, the stylus is configured with a preset communication protocol. After the electronic device receives an input signal, whether the input signal is sent from a pre-configured signal input device is determined by detecting the communication protocol type of the input signal. Specifically, if the communication protocol type of the input signal conforms to the preset communication protocol, the input signal is determined to be sent from a pre-configured signal input device; if the communication protocol type of the input signal does not conform to the preset communication protocol, the input signal is determined not to be sent from a pre-configured signal input device.

Consistent with the present disclosure, adjusting the image content of at least one image of the first image or the second image further includes: adjusting the image content of the second image according to the changed image content of the first image in response to a change in the image content of the first image.

Specifically, when the image content of the first image is a continuously playing video or automatically page-changing text, the image content of the first image will still change even without receiving signal input from the user’s hand or stylus. For example, if the user marks a piece of text in the first image (on the second image) at one moment, and the position of that text in the first image changes at another moment, the mark on the second image can change synchronously according to the change in the position of that text in the first image, indicating the location of the marked text to the user.

Consistent with the present disclosure, when the input signal represents an operation instruction for the second image, the method further includes: determining an input position of the input signal corresponding to the second image in response to receiving the input signal; using the input signal as an input to a pre-configured artificial intelligence model (AI model), and outputting a processing result of the AI model at the input position.

Specifically, the electronic device integrates an AI model to recognize the user’s intent of operation, thereby helping the user perform operations on the second image. For example, when a user circles and annotates a piece of foreign text in the first image within the second image, the AI model recognizes the user’s annotation action to determine if the user intends to translate the text. Therefore, the translation result is displayed around the text.

In some embodiments, outputting the processing results of the AI model includes, but are not limited to, generating text or images from the marked image; performing semantic understanding and text expansion on the marked text; and performing role recognition on the marked individual objects.

In some embodiments, before the AI model executes the processing result, the AI model can also confirm with the user to determine whether the currently executed processing operation meets the user’s expectations.

Consistent with the present disclosure, determining that a preset condition is met includes determining that the preset condition is met when a target signal is received from a signal input device, the target signal being sent by the signal input device in response to a preset operation on the signal input device.

Specifically, the signal input device can be operated by the user to send a target signal to an electronic device, and the electronic device, upon receiving the target signal, determines that a preset condition is met. For example, when the signal input device is configured as a stylus, pressing a button on the end of the stylus causes the stylus to send the target signal.

In some embodiments, in response to a specific user gesture type, determining that a preset condition is met.

Specifically, besides waking the second state of the electronic device using the stylus, the user can also use specific gesture types, including but not limited to swiping and clicking on the electronic device image.

Consistent with the present disclosure, after the image content of the at least one image of the first image or the second images is adjusted, the method further includes: saving the adjusted image content of the second image when the at least one image is the second image; saving the adjusted image content of the second image and the image content of the first image separately when the at least one image includes a second image; and generating a link address for the image content of the at least one image based on the adjusted image content of the at least one image.

Specifically, after the image content of the first image or the second image is adjusted, the adjusted image content is saved for easy viewing by the user later.

For example, when the image content of the first image is static content such as an e-book or picture, and only the image content of the second image is adjusted, the image content of the second image may include annotation information about the first image. For example, text or other content recorded by the user in the second image is saved.

Furthermore, when the at least one image includes a second image, the adjusted content may also include the image content of the first image. If the image content of the first image is adjusted, the adjusted image content of the second image and the image content of the first image are saved separately. While saving the adjusted image content of the second image, the corresponding image content in the first image is associated and saved. When the user subsequently views the recorded text, the content in the corresponding ebook or image can be viewed.

Furthermore, for the adjusted image content of the at least one image, a link address for the image content of the at least one image is generated. The user can then directly jump to the corresponding adjusted image content of the at least one image via the link address.

Through the above method, after the image content is adjusted, the function of saving the adjusted image content and generating a link address is provided. This allows users to conveniently manage and share their work or annotations on the second image.

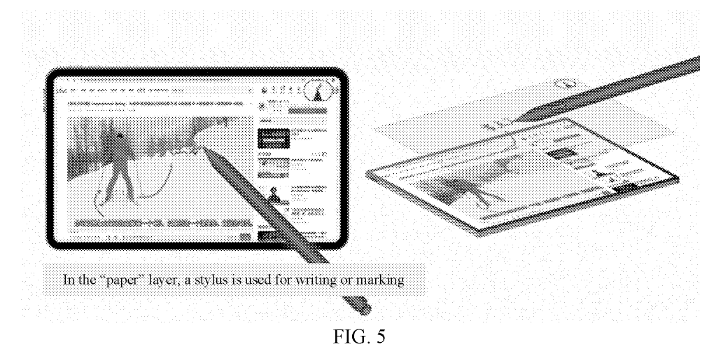

FIG. 5 schematically illustrates a second scenario of image content adjustment in an electronic device consistent with the present disclosure.

Exemplarily, as shown in FIG. 5, when the image content of the first image is video content, since the video content is constantly changing, and the video content may vary significantly when the user watches the video through an application or website, directly saving the video content would consume a large amount of storage space and might also result in video saving failures. Therefore, after the adjusted second image content is saved, a link address for the image content in the first image is also generated. For example, multiple link addresses can be generated sequentially for respective time points with marks on a timeline of the video content. When the user views one of the marks, the user can further jump to a corresponding playback time point of the video content through a corresponding link address.

When a link address for video content is being generated, if the user’s mark on the second image does not correspond to a specific time point in the video content, the link address can be generated directly without including a time point of the video content in the link address.

Consistent with the present disclosure, the method further includes: when the electronic device is not outputting the first image, in response to receiving a control command, the electronic device switches to a third state and outputs the second image.

Specifically, when the user is using the electronic device, even if the electronic device is not outputting the first image (e.g., in an image-off state), the electronic device can still display the second image after receiving a control command. In this case, the second image is not used to record the user’s mark for a specific image content, but only serves as a recording tool.

Through the above method, users can also use the electronic device directly as “paper,” facilitating the recording of their thoughts anytime, anywhere.

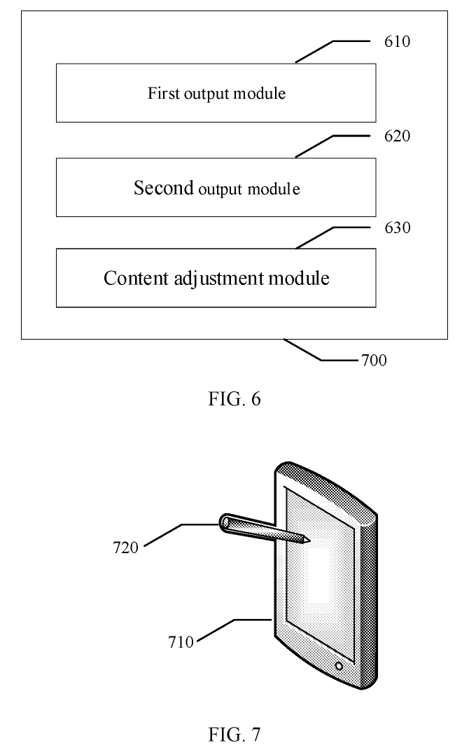

Based on the above control method, the present disclosure also provides an electronic device. The electronic device will be described in detail below with reference to FIG. 6.

FIG. 6 is a structural schematic diagram of an electronic device consistent with the present disclosure. The electronic device includes a first output module 610, a second output module 620, and a content adjustment module 630.

The first output module 610 is configured to output a first image when the electronic device is in a first state.

The second output module 620 is configured to switch the electronic device to a second state in response to a preset condition being met, and output the first image and the second image, the image content of the first image being visible in the second state.

The content adjustment module 630 is configured to adjust the image content of at least one image of the first image or the second image in response to receiving an input signal, the input signal representing an operation instruction for the first image or the second image.

Any or more of the modules, submodules, units, and subunits according to embodiments of the present disclosure, or at least part of the functions of any or more of them, can be implemented in one module. Any or more of the modules, submodules, units, and subunits according to embodiments of the present disclosure can be implemented by dividing them into multiple modules. Any or more of the modules, submodules, units, and subunits according to embodiments of the present disclosure can be at least partially implemented as hardware circuitry, such as a Field-Programmable Gate Array (FPGA), a Programmable Logic Array (PLA), a System-on-Chip, a System-on-a-Substrate, a System-on-Package, an Application-Specific Integrated Circuit (ASIC), or implemented in hardware or firmware by any other reasonable means of integrating or packaging circuitry, or implemented in software, hardware, or firmware, or in any suitable combination of any of these three implementation methods. As another example, one or more of the modules, submodules, units, and subunits according to embodiments of the present disclosure can be at least partially implemented as computer program modules, when executed, can perform corresponding functions.

For example, any multiple of the first output module 610, the second output module 620, and the content adjustment module 630 can be combined into one module/unit/subunit, or any one of these modules/units/subunits can be divided into multiple modules/units/subunits. As another example, at least a portion of the functionality of one or more of the modules/units/subunits can be combined with at least a portion of the functionality of other modules/units/subunits and implemented within a single module/unit/subunit. According to embodiments of the present disclosure, at least one of the first output module 610, the second output module 620, or the content adjustment module 630 can be at least partially implemented as hardware circuitry, such as a Field Programmable Gate Array (FPGA), a Programmable Logic Array (PLA), a System-on-Chip, a System-on-Substrate, a System-on-Package, an Application-Specific Integrated Circuit (ASIC), or any other reasonable method of integrating or packaging circuitry, or implemented in software, hardware, or firmware, or in any suitable combination of any of these three methods. As another example, at least one of the first output module 610, the second output module 620, or the content adjustment module 630 can be at least partially implemented as a computer program module that, when executed, performs a corresponding function.

FIG. 7 structural schematic diagram of an interactive system suitable for implementing the methods described above according to embodiments of the present disclosure.

The interactive system includes an electronic device 710 and a stylus 720.

The electronic device 710 is configured to output a first image when the electronic device is in a first state; and to respond to a preset condition being met, the electronic device switches to a second state and outputs the first image and the second image, the image content of the first image being visible in the second state; in response to receiving an input signal, the image content of at least one image of the first image or the second image is adjusted, the input signal representing an operation instruction for the first image or the second image.

The stylus 720 is configured to input the input signal.

It should be noted that the interactive system part in the embodiments of the present disclosure corresponds to the control method part in the embodiments of the present disclosure.

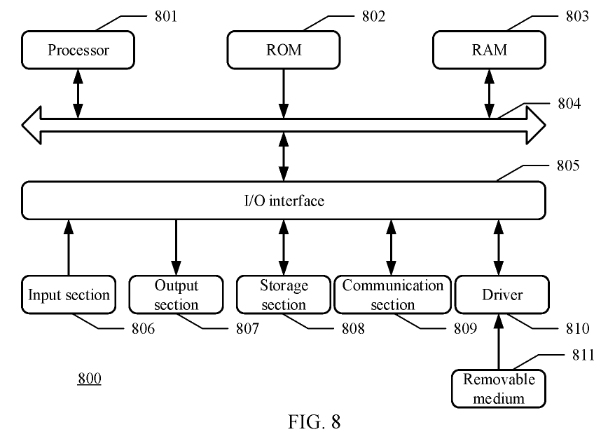

FIG. 8 is a structural schematic diagram of another electronic device suitable for implementing the method described above consistent with the present disclosure. The electronic device shown in FIG. 8 is merely an example and should not impose any limitations on the functionality and scope of the present disclosure.

As shown in FIG. 8, the electronic device 800 consistent with the present disclosure includes a processor 801, the processor 801 can perform various appropriate actions and processes according to a program stored in a read-only memory (ROM) 802 or a program loaded from a storage portion 808 into a random access memory (RAM) 803. Processor 801 may include, for example, a general-purpose microprocessor (e.g., a CPU), an instruction set processor and/or an associated chipset and/or a special-purpose microprocessor (e.g., an application-specific integrated circuit (ASIC)), etc. Processor 801 may also include onboard memory configured for caching purposes. Processor 801 may include a single processing unit or multiple processing units configured to perform different actions of the method flow according to embodiments of the present disclosure.

In RAM 803, various programs and data required for the operation of electronic device 800 are stored. Processor 801, ROM 802, and RAM 803 are interconnected via bus 804. Processor 801 performs various operations of the method flow according to embodiments of the present disclosure by executing programs in ROM 802 and/or RAM 803. It should be noted that the programs may also be stored in one or more memories other than ROM 802 and RAM 803. Processor 801 may also perform various operations of the method flow according to embodiments of the present disclosure by executing programs stored in said one or more memories.

According to embodiments of the present disclosure, the electronic device 800 may further include an input/output (I/O) interface 805 connected to the bus 804. The electronic device 800 may also include one or more of the following components connected to the input/output (I/O) interface 805: an input section 806 including a keyboard, mouse, etc.; an output section 807 including a cathode ray tube (CRT), liquid crystal display (LCD), etc., and a speaker, etc.; a storage section 808 including a hard disk, etc.; and a communication section 809 including a network interface card such as a LAN card, modem, etc. The communication section 809 performs communication processing via a network such as the Internet. A driver 810 is also connected to the input/output (I/O) interface 805 as needed. A removable medium 811, such as a disk, optical disk, magneto-optical disk, semiconductor memory, etc., is installed on the driver 810 as needed to enable computer programs to read from the removable medium 811 can be installed into the storage section 808 as needed.

According to embodiments of the present disclosure, the method flow according to embodiments of the present disclosure can be implemented as a computer software program. For example, embodiments of the present disclosure include a computer program product including a computer program carried on a computer-readable storage medium, the computer program containing program code configured to perform the methods shown in the flowchart. In some embodiments, the computer program can be downloaded and installed from a network via communication section 809, and/or installed from removable medium 811. When the computer program is executed by processor 801, the computer program performs the functions defined in the system of embodiments of the present disclosure. According to embodiments of the present disclosure, the systems, devices, apparatuses, modules, units, etc., described above can be implemented by computer program modules.

The present disclosure also provides a computer-readable storage medium, the computer-readable storage medium may be included in the devices/apparatus/systems described in the above embodiments; or the computer-readable storage medium may exist independently and not assembled into the device/apparatus/system. The aforementioned computer-readable storage medium carries one or more programs that, when executed, implement the methods according to embodiments of the present disclosure.

According to embodiments of the present disclosure, the computer-readable storage medium may be a non-volatile computer-readable storage medium. Examples may include, but are not limited to: portable computer disks, hard disks, random access memory (RAM), read-only memory (ROM), erasable programmable read-only memory (EPROM or flash memory), portable compact disk read-only memory (CD-ROM), optical storage devices, magnetic storage devices, or any suitable combination thereof. Consistent with the present disclosure, a computer-readable storage medium can be any tangible medium that contains or stores a program that can be used by or in conjunction with an instruction execution system, apparatus, or device.

For example, according to embodiments of the present disclosure, a computer-readable storage medium may include ROM 802 and/or RAM 803 and/or one or more memories other than ROM 802 and RAM 803 described above.

Embodiments of the present disclosure also include a computer program product including a computer program containing program code configured to perform the methods provided in embodiments of the present disclosure. When the computer program product is executed on an electronic device, the program code is configured to cause the electronic device to implement the remote sensing image detection method based on a deep neural network provided in embodiments of the present disclosure.

When the computer program is executed by processor 801, the computer program performs the functions defined in the system/apparatus of embodiments of the present disclosure. According to embodiments of the present disclosure, the systems, devices, modules, units, etc., described above can be implemented using computer program modules.

In one embodiment, the computer program can rely on tangible storage media such as optical storage devices or magnetic storage devices. In some embodiments, the computer program can also be transmitted and distributed in the form of signals over a network medium, and downloaded and installed via communication section 809, and/or installed from removable medium 811. The program code contained in the computer program can be transmitted using any suitable network medium, including but not limited to wireless, wired, etc., or any suitable combination thereof.

According to embodiments of the present disclosure, program code configured to execute the computer programs provided in embodiments of the present disclosure can be written in any combination of one or more programming languages. Specifically, the computational programs can be implemented using high-level procedural and/or object-oriented programming languages, and/or assembly/machine languages. Programming languages include, but are not limited to, languages such as Java, C++, Python, “C”, or similar programming languages. The program code can be executed entirely on a user computing device, partially on a user device, partially on a remote computing device, or entirely on a remote computing device or server. In cases involving remote computing devices, the remote computing devices can be connected to user computing devices via any type of network, including local area networks (LANs) or wide area networks (WANs), or the remote computing devices can be connected to external computing devices (e.g., via the Internet using an Internet service provider).

The flowcharts and diagrams in the accompanying drawings illustrate the architecture, functionality, and operation of possible implementations of systems, methods, and computer program products according to various embodiments of the present disclosure. In this regard, each block in a flowchart or block diagram may represent a module, segment, or portion of code containing one or more executable instructions configured to perform a specified logical function. It should also be noted that in some embodiments, the functions indicated in the blocks may occur in a different order than those indicated in the drawings. For example, two consecutively indicated blocks may actually be executed substantially in parallel, and they may sometimes be executed in reverse order, depending on the functions involved. It should also be noted that each block in the block diagram or flowchart, and combinations of blocks in the block diagram or flowchart, can be implemented using a dedicated hardware-based system that performs the specified function or operation, or using a combination of dedicated hardware and computer instructions. Those skilled in the art will understand that the features described in the various embodiments of the present disclosure can be combined and/or combined in various ways, even if such combinations or combinations are not explicitly described in the present disclosure. In particular, the features described in the various embodiments of the present disclosure can be combined and/or combined in various ways without departing from the spirit and teachings of the present disclosure. All such combinations and/or combinations fall within the scope of the present disclosure.

The embodiments of the present disclosure have been described above. However, these embodiments are merely illustrative and not intended to limit the scope of the present disclosure. Various embodiments have been described above. Embodiments of the present disclosure are for illustrative purposes only and are not intended to limit the scope of the present disclosure. The described embodiments do not mean that the measures in the various embodiments cannot be used advantageously in combination. Various substitutions and modifications can be made by those skilled in the art without departing from the scope of the present disclosure, and all such substitutions and modifications should fall within the scope of the present disclosure.

What is claimed is:

1. A control method comprising:
outputting a first image when an electronic device is in a first state;
in response to a preset condition being met, switching the electronic device to a second state and outputting the first image and a second image, first image content of the first image being visible in the second state; and
in response to receiving an input signal, adjusting at least one of the first image content or second image content of the second image, the input signal representing an operation instruction for the first image or the second image.

2. The method according to claim 1,
wherein the second image is configured to be located on top of the first image;
the method further comprising:
adjusting the second image content to enable the first image content to be visible in the second state.

3. The method according to claim 2, wherein adjusting the second image content includes:
adjusting image transparency of the second image to a preset value.

4. The method according to claim 2, wherein adjusting the second image content includes:
adjusting the second image content based on the first image content to enable the first image content to be displayed at the second image.

5. The method according to claim 1, wherein adjusting at least one of the first image content or the second image content includes:
in response to the input signal being sent by a pre-configured signal input device, adjusting the second image content according to the input signal; and
in response to the input signal not being sent by the pre-configured signal input device, adjusting the first image content according to the input signal.

6. The method according to claim 1, wherein adjusting the at least one of the first image content or the second image content further includes:
in response to a change in the first image content, adjusting the second image content according to the first image content after being changed.

7. The method according to claim 1,
wherein the input signal represents the operation instruction for the second image;
the method further comprising:
in response to receiving the input signal, determining an input position of the input signal in the second image; and
inputting the input signal to a pre-configured artificial intelligence model, and outputting a processing result of the artificial intelligence model at the input position.

8. The method according to claim 1, wherein the preset condition includes:
receiving a target signal sent by a pre-configured signal input device, the target signal being sent by the signal input device in response to a preset operation on the signal input device.

9. The method according to claim 1,
wherein adjusting the at least one of the first image content or the second image content includes adjusting the second image content;
the method further comprising:
saving the second image content after being adjusted.

10. The method according to claim 1,
wherein adjusting the at least one of the first image content or the second image content includes adjusting at least the second image content;
the method further comprising:
separately saving the second image content after being adjusted and the first image content.

11. The method according to claim 1, further comprising, after adjusting the at least one of the first image content or the second image content:
generating a link address for the at least one of the first image content or the second image content after being adjusted.

12. An interactive system comprising:
an electronic device configured to:
output a first image when the electronic device is in a first state;
in response to a preset condition being met, switch to a second state and output the first image and a second image, first image content of the first image being visible in the second state; and
in response to receiving an input signal, adjust at least one of the first image content or second image content of the second image, the input signal representing an operation instruction for the first image or the second image; and
a stylus configured to input the input signal.

13. An electronic device comprising:
a processor; and
a memory storing an application program that, when executed by the processor, causes the electronic device to:
output a first image when the electronic device is in a first state;
in response to a preset condition being met, switch to a second state and output the first image and a second image, first image content of the first image being visible in the second state; and
in response to receiving an input signal, adjust at least one of the first image content or second image content of the second image, the input signal representing an operation instruction for the first image or the second image.

14. The electronic device according to claim 13, wherein:
the second image is configured to be located on top of the first image; and
the application program, when executed by the processor, further causes the electronic device to:
adjust the second image content to enable the first image content to be visible in the second state.

15. The electronic device according to claim 14, wherein the application program, when executed by the processor, further causes the electronic device to, when adjusting the second image content:
adjust image transparency of the second image to a preset value.

16. The electronic device according to claim 14, wherein the application program, when executed by the processor, further causes the electronic device to, when adjusting the second image content:
adjust the second image content based on the first image content to enable the first image content to be displayed at the second image.

17. The electronic device according to claim 13, wherein the application program, when executed by the processor, further causes the electronic device to, when adjusting at least one of the first image content or the second image content:
in response to the input signal being sent by a pre-configured signal input device, adjust the second image content according to the input signal; and
in response to the input signal not being sent by the pre-configured signal input device, adjust the first image content according to the input signal.

18. The electronic device according to claim 13, wherein the application program, when executed by the processor, further causes the electronic device to, when adjusting the at least one of the first image content or the second image content:
in response to a change in the first image content, adjust the second image content according to the first image content after being changed.

19. The method according to claim 1,
wherein the input signal represents the operation instruction for the second image;
the application program, when executed by the processor, further causes the electronic device to:
in response to receiving the input signal, determine an input position of the input signal in the second image; and
input the input signal to a pre-configured artificial intelligence model, and output a processing result of the artificial intelligence model at the input position.

20. The electronic device according to claim 13, wherein the preset condition includes:
receiving a target signal sent by a pre-configured signal input device, the target signal being sent by the signal input device in response to a preset operation on the signal input device.
